(19) United States
(12) Patent Application Publication
(10) Pub. No.: US 2004/0050777 A1
(43) Pub. Date: Mar. 18, 2004

(54) Integrated anaerobic waste management system with energy and products recovery

(75) Inventor: Zia Khan, Stockton, CA (US)

Correspondence Address: Biowaste Energy, Inc., 15405 N. Locust Tree Rd., Lodi, CA, 95240, US

(73) Assignee: Biowaste Energy, Inc., Lodi, CA

(21) Appl. No.: 10/232,594

(22) Filed: Sep. 3, 2002

(51) Int. Cl. C02F 3/00

(52) U.S. Cl. 210/603

(57) ABSTRACT

This invention provides a more complete conversion of concentrated organic waste materials into methane, carbon dioxide, liquid fertilizer, soil amendments and water that meets potable water criteria. The process utilizes sequential and unique application of several technologies. Reverse Osmosis technology is used for concentration of liquids and water purification. Anaerobic Reactors are used for volatile solid destruction which produces methane, carbon dioxide, nutrient rich liquid and soil amendment. Molecular Reformer, based on vortex, cavitation and hydrocyclone technologies, processes waste for optimum anaerobic digestion thus improving anaerobic reactor efficiency.

### FIELD OF THE INVENTION

### Innovative Approach to Concentrated Biodegradable Wastes

This invention provides a more complete conversion of concentrated organic waste materials into methane, carbon dioxide, liquid fertilizer, soil amendments and water that meets potable water criteria. The process utilizes sequential and unique application of several technologies. Reverse Osmosis technology is used for concentration of liquids and water purification. Anaerobic Reactors are used for volatile solid destruction which produces methane, carbon dioxide, nutrient rich liquid and soil amendment. Molecular Reformer, based on vortex, cavitation and hydrocyclone technologies, processes waste for optimum anaerobic digestion thus improving anaerobic reactor efficiency.

1.1. Summary of the Invention

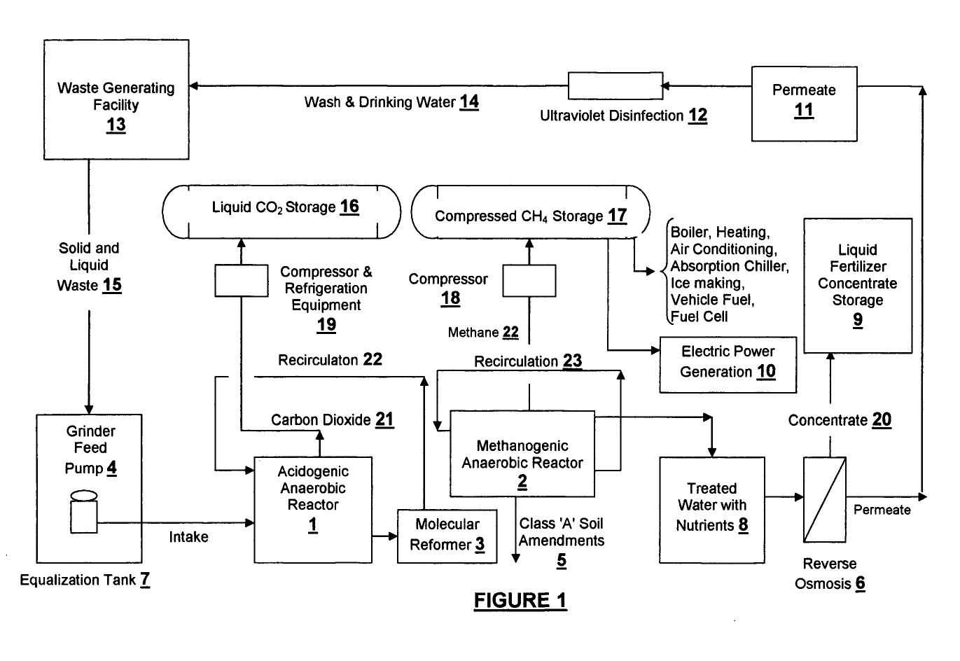

The diagram attached hereto and incorporated herein as FIG. 1 illustrates the basic design of the Company's wastewater treatment and co-product recovery system. Wastewater enters into an Equalization 7 Tank, from the Equalization Tank it is picked up by Grinder Feed Pump 4 and fed into the high temperature (˜140° F./60° C.) Acidogenic Anaerobic Reactor 1. Additionally, the wastewater is recirculated through a proprietary Molecular Reformer 3.

The following products exit the Anaerobic Reactor:

1.1.1. Carbon Dioxide 21

Carbon Dioxide exits Acidogenic Anaerobic Reactor 1 and it is compressed, liquefied and stored for sale.

1.1.2. Methane

Methane exits Methanogenic Reactor 2 and it is compressed and stored for usage at the site for Electricity Generation, Heating, Air Conditioning, and/or Ice Making or sold as CNG (Compressed Natural Gas).

1.1.3. Pathogen Free Treated Water with Nutrients 8

This effluent is pathogen free as it has spent several hours in a high temperature environment in the Anaerobic Reactor. Treated water with nutrients is separated by Reverse Osmosis Membranes 6 into concentrated Liquid Fertilizer 20 and Permeate Water 11. Liquid Fertilizer is sold to the manufacturers of various fertilizer cocktails. Permeate water goes through ultraviolet disinfection 12 and could be used for animal drinking and/or as wash water.

Soil Amendment

Pathogen free, class ‘A’ bio-solids 5 (Soil Amendment) with micro nutrients such as Calcium, Copper, Iron and Zinc are sold to farmers or in bulk to suppliers of soil conditioners.

1.1.4. Prior Art

Patents exist for anaerobic digestion of biodegradable wastes. Important examples include Steiner (U.S. Pat. No. 5,630,942) and Ghosh (U.S. Pat. No. 4,318,993) for thermophilic, 2 stage anaerobic treatment, where the acidogenic phase of the biochemical process is separated from the methanogenic phase. Our technology improves on the prior art by the following: 1. improved recirculation in the digester, 2) improved media to support fixed organisms, 3) improved processing of off-gases and solids for beneficial recovery, and 4) improved automatic control of the key biochemical and physical processes for optimal energy and materials recovery.

### DETAILED DESCRIPTION

### Optimized Energy and Materials Recovery from Organic Wastes

Optimal Processing System for Concentrated Organic Wastes

Concentrated organic wastes from crop production, confined animal feeding, food processing, etc. generate substantial water, air, and soil pollution problems. But they also provide opportunities for energy, nutrient, and water recovery. This technology, initially focused on processing wastes from large confined dairy cattle operations, addresses the fill scope of issues in feedstock processing, anaerobic process control, and effluent treatment to reduce pollution potentials and maximize energy and products recovery.

Anaerobic treatment of wastes with high organic content, measured as BOD and COD, has long been recognized as a viable process for volume reduction, waste water treatment, and energy recovery. For such systems, however, process design and process control have been key issues. The following patents cited demonstrate the scope of thinking about anaerobic technology, with a few examples addressing feedstock preparation and a few others addressing effluent management issues. The technology proposed for patent protection demonstrates improvements in both process design and process control.

The key elements, working in combination in the proposed technology, and establishing its unique and innovative characteristics are as follows:

1. Feed pretreatment and flow control to optimize anaerobic reactor performance. These elements include sand removal, grinding, feedstock mixing, etc. to provide materials of appropriate size, solids concentration, contaminant removal, and feed rate for the digester. Sophisticated arrangements of feedstock sourcing, pumps, filters, and mixers will be necessary to accomplish this goal. Many of these components are known in the art, but their arrangement and application will be unique.

2. Anaerobic Process Control. This technology recognizes that the key biochemical steps in anaerobic digestion, namely hydrolysis, acidogenesis, and methanogenesis, are distinctly different, and that they must be carried out under separately optimal conditions. Aspects of the technology used to achieve this process control are:

a. separation of the acid tank from the methane producing tank

b. fixed media in the processing tanks

c. recirculation of process liquids

d. molecular disruption technology to enhance biodegradation of hard to digest organic materials

e. recirculation of product gases and other gases as necessary

f. addition of nutrients and enzymes to enhance gas production

g. computer control of pH, flows, current draw, pressures, etc. for automatic process control

h. operation of the digester in upflow and downflow modes as appropriate for the feedstocks.

3. Effluent management. Solids, liquids, and gases produced from the anaerobic digestion must be separated and sometimes, concentrated. The (bio)gas collected in acidogenic reactor will consist about 95% of carbon dioxide, 5% of methane and trace of other gases such as hydrogen sulfide. The (bio)gas collected in methogenic reactor will consist about 95% of methane, 5% of carbon dioxide and trace of other gases., Both carbon dioxide and methane will be prepared for sale, and methane will be converted to electricity (Boiler fuel, heat, air condition, absorption chiller, ice maling, vehicle fuel, and fuel cell).

While most of the technology for meeting these objectives is known to those skilled in the art, the process of transforming water contaminated with organic matter back to water of drinkable quality, and to produce commercial quality gases and electricity, will involve innovative application and extensions of generally known principles. The inventor's previous experience with large-scale reverse osmosis systems and with power generation equipment will be applied to these tasks. Residual solids and nutrients from the process will be processed to meet the requirements for sale in the agricultural and horticultural markets.

The unit will be self-contained and portable. These features will enhance capabilities for long-distance monitoring, maintenance and repair, security, and related considerations.

Patent Reference Documents

| | | |
|---|---|---|
| 4,599,168 | Benjes, et al. | Anaerobic digestion |
| 5,529,692 | Kubler | Anaerobic digestion |
| 6,342,378 | Zhang | Anaerobic digestion |
| 5,630,942 | Steiner | Anaerobic digestion |
| 4,022,665 | Ghosh et al. | Anaerobic digestion |
| 4,696,746 | Ghosh et al. | Anaerobic digestion |
| 6,254,775 | McElvaney | Anaerobic digestion and ultrafiltration |
| 6,333,181 | Ingram et al. | Ultrasound for anaerobic feedstock |
| | | preparation |
| 4,981,592 | Garbutt et al. | Enzyme addition to anaerobic digestion |
| 6,361,694 | Trost | Propane addition to anaerobic digestion |
| 5,500,123 | Srivastava | Two phase anaerobic digestion |
| 6,007,719 | Yoo et al. | Anaerobic digestion and membrane |
| | | separation |
| 4,919,813 | Weaver | Photoenhanced anaerobic digestion |
| 6,391,203 | Fassbinder | Enhanced biogas production |
| 5,091,315 | McCarthy | Bioconversion reactor |
| 4,735,724 | Chynoweth et al. | Anaerobic reactor |
| 6,296,766 | Breckenridge | Anaerobic digester system |

### OTHER REFERENCE

Kansal, Arun; k. V. Rajeshwari, Kusum Lata, V. V. N. Kishore, “Anaerobic digestion technologies for energy recovery from industrial wastewater—a study in the Indian context,” TERI Monitor on Environmental Science 3 (2): 67-75, December 1998.

Hoyt, Stephen, “Methane Production from a pilot-scale fixed-film anaerobic digester and plug-flow digester loaded with high-solids dairy manure,” the Dubara Company, Castleton, N.Y. 12033, final report to the Vermont Department of Public Service, no date.

Kawamura, T., “Temperature phased two stage anaerobic digestion for high solids content organic matters, M. Sc. Thesis, Iowa State University, Ames, Iowa, September 1999.

Raven, P., P. Battistoni, F. Cecchi, and J. Alverez, “Two phase anaerobic digestion of source separated OFMSW (organic fraction of municipal solid waste): performance and kinetic study,” Water Science and Technology, 41:3, 111-118, 2000.

Von Sachs, Jurgen, Heiko Feitenhauer, and Ulrich Meyer, “Monitoring and control system for the anaerobic degradation of wastewater containing inhibitory substances,” Laboratorium fur Technische Chemie, Zurich, Switzerland, accessed on 04/06/2002 at www.tech.chem.ethz.ch/rysgroup/poster1/poster1.html

Zhang, R. H., J. Tao, and P. N. Dugba, “Evaluation of two-stage anaerobic sequencing batch reactor systems for animal wastewater treatment,” Transactions of the ASAE (American Society of Agricultural Engineers) 43 (6): 1795-1801, 2001.

Dugba, P. N., R. H. Zhang, T. T. Rumsey, and T. G. Ellis, “Computer simulation of two-stage anaerobic sequencing batch reactor system for animal wastewater treatment, Transactions of the ASAE, 42 (2): 471-477, 2000.

Shafer, Perry L., and Joseph B. Farrell, “Turn up the heat: anaerobic digestion systems,” Water Environment and Technology, pp. 27-32, November 2000.

Russell, James B. and Jennifer L. Rychlik “Factors that Alter Rumen Microbial Ecology,” Science, (292), 11 May 2001, 1119-1120.

Azbar, Nuri, and Richard E. Speece, “Two-phase, two-stage, and single-stage anaerobic process comparison,” Journal of Environmental Engineering, 127 (3): 240-248, 2001.

McCarthy, Perry, and D. P. Smith, “Anaerobic wastewater treatment: fourth part of a six-part series on wastewater treatment processes,” Environmental Science and Technology, 20 (12), 1200-1206, 1986.

Common Terms (this discussion follows the McElvaney patent)

There are several terms used to describe any anaerobic bioconversion process and its parameters:

Total Solids (TS)

All organic matter contains some water. The human body is approximately 70% water. Total Solids (TS) is a measure of the actual solid content of a substance. Only portions of the solid material are actually bio-converted. TS is determined by weighing a sample, oven-drying it to remove all moisture, and then re-weighing the dried sample. TS % is determined by dividing the “dry” weight by the “wet” weight. The same human body is therefore 30% TS.

Volatile Solids (VS)

Volatile Solids (VS) is a measure of the solids (portion of TS) which are actually available for bioconversion. VS is determined by “burning” the dried TS sample, which removes the “volatile” component. What remains is non-volatile (see NVS below). The sample is weighed again to determine this “ash” weight, which is subtracted from TS to determine VS. VS % is found by dividing VS by TS.

Non-Volatile Solids (NVS)

Non-Volatile Solids (NVS) is what remains in a sample after removing the VS in a furnace. NVS (mostly minerals in ash form) are not bio-convertible. NVS % is determined by dividing NVS by TS.

Hydraulic, Solids, Microorganism Retention Time(s) (HRT, SRT, MRT)

Retention Time(s) refers to how long a given material is kept (retained) in the system. The units are days. Hydraulic Retention Time (HRT) measures the length of time that liquid remains in the system. HRT is determined by dividing system volume by feedstock volume. Solids Retention Time (SRT) is the length of time that feedstock solids remain in the system. Microorganism Retention Time (MRI) is the length of time that the anaerobic bacteria (microorganisms) remain in the system. Longer MRT's, which can be achieved by using a growth matrix, promote increased system stability while simultaneously reducing nutrient requirements (see below).

Organic Loading Rate (kg VS/m³-day)

Organic Loading Rate is a measure of the organic material (VS), per bioconverter volume, added to the system on a daily basis. The units are kg VS/m³-day. The value is determined during engineering. For a given system size, higher organic loading rates generally result in lower bioconversion efficiency. Any value greater than 3.3 kg VS/m³-day is considered high-rate bioconversion.

Methane Yield (m³ CH₄ / kg VS added)

Methane Yield is a measure of the quantity of methane produced from the VS which are added to the system. The units are m³ CH4/ kg VS added. The value is dependent upon the type and digestibility of the feedstock and the retention time in the system. It is also affected by the condition of the fermentation (raw gas quality). 1 kg VS 100% bio-converted into 100% methane would yield 1.4 m³. More typically, 1 kg VS is 70% bio-converted into 65% methane, yielding 0.4 m³.

Methane Production Rate (m³/m³-day)

Methane Production Rate is a measure of the quantity of methane, per Bio-Converter volume, generated by the system on a daily basis. The units are m³/m³-day. A value of 1 m³/m³-day is reasonable. Methane production rates are proportional to the sulfur required for bioconversion, because more H₂S is carried away during vigorous gassing.

Volatile Acids Concentration

Volatile acids are measured to determine the equivalent buffering capacity which may be needed for bioconversion to proceed. The relative concentration of volatile acids affects the overall pH. If the volatile acids concentration exceeds the ability of the bicarbonate allkalinity to maintain the pH above 6.5, then the fermentation turns acid and methane formation ceases.

Bicarbonate Alkalinity (CaCO₃, mg/l)

Bicarbonate Alkalinity is a parameter which provides an estimate of the buffering capacity of a fermentation The units are mg/liter, expressed as CaCO₃. Bicarbonate alkalinity is usually derived from the solubilization of carbon dioxide, which results from the bioconversion of organic wastes. During bioconversion, acids are formed as intermediary compounds. To the degree sufficient bicarbonate alkalinity is present, high loading rates of solids to the bioconversion unit can occur without the need to make pH adjustments.

Chemical Oxygen Demand (COD, mg/l)

Chemical Oxygen Demand (COD) is a parameter which provides an estimate of the quantity of organic material in a sample. The units are mg/I. The value returned is dependent upon the type of sample being tested. Samples of feedstock may measure 100,000+ mg/l, while filtrate samples are generally around 2000 mg/l. The test itself is an EPA-approved method which provides faster, more repeatable results than the more common Biological Oxygen Demand (BOD) test.

It will be recognized by those skilled in the art that the following claims are subject to some variation in their embodiments without altering the spirit of the invention.

I claim the following:

1. a novel, integrated anaerobic digestion system for processing concentrated (high BOD and COD with high VSS) organic wastes and recovering valuable by-products and energy

2. a more efficient anaerobic digester using multiple stages, fixed film, recirculation, nutrient addition, and thermophilic temperatures as described above

3. a computer control system to optimize process operations and to maintain functionality both within the digester and for the entire integrated operation.

4. a novel molecular disruption device to prepare feedstocks more efficiently for anaerobic digestion and to cause aerobic and anaerobic digestion of complex organic molecules.
